(19) United States
(12) Patent Application Publication
(10) Pub. No.: US 2005/0068863 A1
(43) Pub. Date: Mar. 31, 2005

(54) METHOD FOR CONTROLLING PICK-UP HEAD DURING A LONG SEEK

(76) Inventors: Jen-Yu Hsu, Taipei City (TW); Hsiang-Yi Fu, Taipei City (TW); Tun-Chieh Lee, Taipei City (TW); Fu-Hsiang Chen, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/711,528

(22) Filed: Sep. 23, 2004

(30) Foreign Application Priority Data
Sep. 29, 2003 (TW) 092126909

(51) Int. Cl. G11B 7/00

(52) U.S. Cl. 369/44.28; 369/53.25

(57) ABSTRACT

The present invention discloses a method for controlling a pick-up head during a long seek. During a long seek, a bias voltage is applied to the pick-up head to overcome the inertia of the pick-up head and to prevent the pick-up head from oscillating. This makes it easier for the optical drive to execute the track-on action after a long seek.

### BACKGROUND OF INVENTION

1. Field of the Invention

The present invention relates to a method for controlling an optical disk drive, and more particularly, to a method for controlling a pick-up head during a long seek.

2. Description of the Prior Art

An optical disk is a type of rapid random access storage media. For this purpose, an optical disk drive must use a seeking servo to control a sledge to the target track at high speed, and then use a tracking servo to track on (or lock) the target track and follow the target track to reproduce the information recorded on the target track.

For example, please refer to FIG. 1 illustrating the track-on action of a prior art pick-up head 24. Generally, when an optical disk drive is performing a long seek, a seeking servo controls a sledge 26 to move to the target track 23 and then a tracking servo control the pick-up head 24 to execute the track on action. Also, the sledge 26 provides a movable range 27 as a fine tuning range for the pick-up head 24 to execute the track on action, following action or short seek. When the pick-up head 24 is not controlled, the elastic device 25 moves the pick-up head to the center of its movable range. When the sledge 26 is driven to the target track 23, as shown in FIG. 1, the tracking servo controls the pick-up head 24 to track on (or lock) the target track 23 of the disk 22.

Please refer to FIG. 2 illustrating the feed motor output (FMO) signal vs. time as the optical disk drive is performing a long seek according to the prior art. An optical disk drive sends an FMO signal to the sledge motor to drive the sledge. To increase the access speed of the optical disk drive, the sledge is driven by a larger force during the beginning of the long seek, and as the sledge approaches the target track, the force becomes smaller to lower the speed of the sledge. As shown in FIG. 2, for example, from time t0 to time t1 when the sledge starts a long seek, the sledge motor, controlled by the FMO signal, applies a larger force on the sledge to make it move rapidly; however, when the sledge is approaching the target place at time t1, the force is lowered under the control of the FMO signal to slow down the sledge so that the pick-up head can successfully execute the track on action.

Generally, because of the larger force applied to the sledge during the beginning of the long seek, the sledge moves so rapidly that the pick-up head moves unstably (back and forth) within its movable range because it is attached to an elastic device 25. Therefore, because the pick-up head is unstable, the track-on action often fails when the sledge arrives at the target track.

To make the track-on action succeed, in the prior art, the pick-up head provides a central error output (CEO) to make sure the position of the pick-up head in the movable range. The CEO is the signal indicating the position at which the pick-up head is located. The CEO is at the zero-crossing point when the pick-up head is at the center of its movable range. Therefore, the actual position of the pick-up head can be detected by checking the CEO.

In the prior art, the control chip of the optical disk drive provides a controlling signal according to the CEO for closed-loop control of the pick-up head. The pick-up head is held at the center of its movable range during a long seek by the control of the controlling signal. However, to reduce the cost of the pick-up head, the CEO is omitted in some specific pick-up heads. When the sledge 26 accelerates towards direction A, as shown in FIG. 3, the pick-up head 24 deviates from the center of its movable range in the direction opposite to the direction A and oscillates due to its inertia. However, when the CEO is omitted, the control chip in the optical disk drive cannot support the closed-loop control, so the pick-up head 24 oscillates in its movable range during a long seek, leading to the failure of the track-on action frequently.

### SUMMARY OF INVENTION

One objective of the claimed invention is to provide a method for controlling a pick-up head of an optical disk drive with no center servo control during long seek to prevent the pick-up head from oscillating, thereby solving the above-mentioned problem.

According to one preferred embodiment of the present invention, a method for controlling a pick-up head during a long seek is disclosed. The method includes identifying an accelerating direction of a sledge; and applying a force on the pick-up head when the sledge is accelerating, wherein the force is in the same direction as the accelerating direction.

According to a second preferred embodiment of the present invention, a method for controlling a pick-up head during a long seeking is also disclosed for used in the pick-up head without a central error output. The method includes driving a sledge by using a Feed Motor Output (FMO) signal; and providing a controlling signal to a pick-up head when the sledge accelerates, wherein the controlling signal drives the pick-up head to accelerate in the same direction as that of the sledge.

It is one advantage of the present invention that a controlling signal is provided to trigger a bias voltage against the inertia of the pick-up head to prevent the pick-up head from oscillating when a long seek is activated, and therefore, the probability of a successful track-on action is increased.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram illustrating a track-on action of a prior art pick-up head.

FIG. 2 is a diagram illustrating a feed motor output (FMO) signal vs. time during a long seek of an optical disk drive according to the prior art.

FIG. 3 is a diagram illustrating the prior art pick-up head lagging behind a sledge due to an inertia of the pick-up head when the sledge is accelerated by a sledge motor.

FIG. 4 is a flowchart of a method for controlling a pick-up head during a long seek according to the present invention.

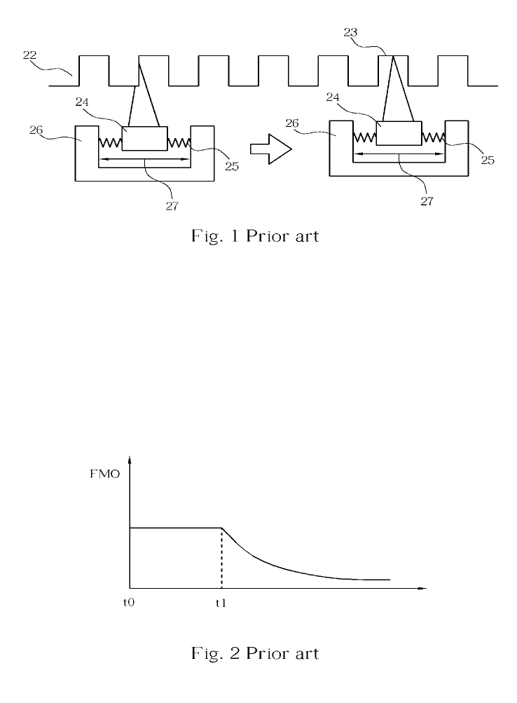

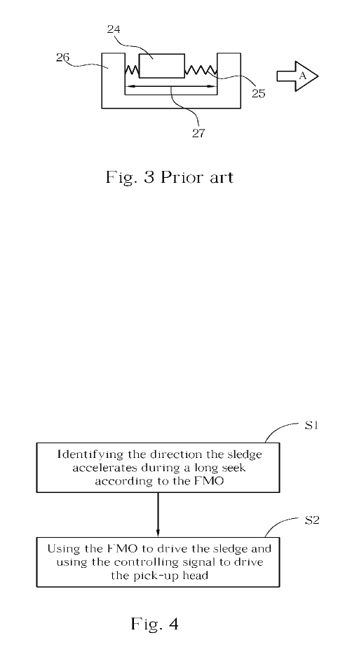

### DETAILED DESCRIPTION

To avoid the oscillation of the pick-up head within its movable range and the resulting failure of the track-on action during a long seek, the invention provides a method for controlling the pick-up head during a long seek. The present invention is applied to a pick-up head without a CEO.

When the sledge is driven during a long seek, the control chip in the optical disk drive must identify the direction in which the sledge accelerates. Then, a bias voltage triggered by the control signal generated by the controlling chip is used to balance the inertia of the pick-up head so that the pick-up head stops oscillating. So, when the sledge motor applies a force to the sledge, the controlling signal forces the pick-up head to accelerate with the same acceleration as the sledge; therefore, the oscillation of the pick-up head can be greatly reduced.

FIG. 4 illustrates the method of the present invention for controlling the pick-up head during a long seek. It includes the following two steps:

S1: Identifying the direction the sledge accelerates during a long seek according to the FMO signal; and

S2: Using the FMO signal to drive the sledge and using the controlling signal to drive the pick-up head.

According to an embodiment of the present invention, because the weights of the sledge and the pick-up head are different, the ratio of the FMO signal to the controlling signal must be determined according to their weights. As a result, the sledge and the pick-up head will have the same acceleration so that the pick-up head stops oscillating.

In the prior art, due to its inertia, the pick-up head moves in the direction opposite to the direction of the sledge. Therefore, the present invention provides a controlling signal to generate a bias voltage against the inertia, so that during a long seek, the pick-up head can be held at a specific position within its movable range, stopping the oscillation of the pick-up head. Consequently, after a long seek, because the pick-up head is stable, the track-on action can then be done more reliably.

The advantage of the present invention is to provide controlling methods for a long seek. During a long seek, a controlling signal is provided to trigger a bias voltage against the inertia of the pick-up head to prevent the pick-up head from oscillating, and therefore, the probability of a successful track-on action is increased.

Those skilled in the art will readily observe that numerous modifications and alterations of the device and method may be made while retaining the teachings of the invention. Accordingly, the above disclosure should be construed as limited only by the metes and bounds of the appended claims.

1. A method for controlling a pick-up head during a long seek, comprising:
identifying an accelerating direction of a sledge; and
when the sledge accelerates, applying a force with a direction identical to the accelerating direction on the pick-up head for driving the pick-up head to move along the accelerating direction.

2. A method for controlling a pick-up head during a long seek for used in the pick-up head without a central error output, comprising:
driving a sledge by using a Feed Motor Output (FMO) signal; and
when the sledge accelerates, providing a controlling signal to the pick-up head for driving the pick-up head to accelerate along an accelerating direction of the sledge.

3. The method of claim 2, wherein a ratio of the FMO signal to the controlling signal is a predetermined value.
